(19) United States
(12) Patent Application Publication
(10) Pub. No.: US 2025/0010439 A1
(43) Pub. Date: Jan. 9, 2025

(54) Self-positioning screw starter

(71) Applicant: Daniel Han, Roanoke, VA (US)

(72) Inventor: Daniel Han, Roanoke, VA (US)

(21) Appl. No.: 18/349,149

(22) Filed: Jul. 9, 2023

(51) Int. Cl. B25B 23/10

(52) U.S. Cl. CPC B25B 23/101

(57) ABSTRACT

A self-positioning screw starter has multiple grab claws, a lock/unlock slider with retention band. Claws are designed to be able to open by elastic material or by coil spring. The slide can be operated by hand or by air-cylinder, motor, or other automatic method.

### CROSS-REFERENCE TO RELATED APPLICATIONS

None.

### BACKGROUND OF THE INVENTION

Start driving screw requires align the screw with the whole. Common method is holding by a hand. While this is not generally too much while one free hand is available and the working space is big enough, those who has no free hands, or the hand can't reach the limited space, or human hands are not allowed at an automatic assemble machine, aligning the screw and hold the position is a challenging. The need has arisen for a means by which a screw can be grabbed and hold the position tightly, without the help of human hands. The development of self-positioning screw starter with lock/unlock mechanism fulfills these

### SUMMARY OF THE INVENTION

The principles of the present invention provide for multiple spring claws, a lock/unlock slider, and a retention band. When the slide is pushed towards to the end of the claws, the claws contract and start to grab the screw head. When the slid reach the end of the claws, which is the lock position, push the screwdriver till the screw head shoulder surface touch completely with the claws, the screw has been locked and positioned. In a manual drive operation, use a band to tie the screw starter with the screwdriver to prevent the screw loose from the screw starter. In an automatic machine, when the slide is controlled by air-cylinder, motor or other mechanism, the band is not necessary.

After screw had been grabbed and locked, move the screw with the screw starter to the screw hole and start to drive the screw in.

Stop the screwdriver after the screw goes into the thread hole enough, before the starter claws touch the work piece. Move the slider of the starter upwards to unlock the screw from the starter. The claws will extract and move out of the screw head by the spring force. The spring force can come from the claw itself, or from the external coil spring force.

Then finish driving the screw to make it tight.

### BRIEF DESCRIPTION OF DRAWINGS

The accompanying drawings can help better understand the advantages and features of the present invention.

FIG. 1 is the exploded view of the present invention of elastic self-expandable claws.

FIG. 2A is the view to show screw is ready to be locked by the elastic starter.

FIG. 2B is the view to show screw has been locked by the starter.

FIG. 3 is the view to show self-expandable claw starter in-use view of the present invention.

FIG. 4 is the exploded view of the present invention of coil spring expand claws.

FIG. 5 is the view to show screw is ready to be locked by the rigid claw's starter.

FIG. 6 is the view to show screw has been locked by spring force expand claws.

FIG. 7 is the view to show coil spring expand claw starter in-use view of the present invention.

FIG. 8 is the assembled view of the spring, hinge, and spring expand claws.

FIG. 9 is the design and view of rigid claws.

FIG. 10 is the design and view of the base for rigid claws.

FIG. 11 is the design and view of the slide for rigid claws.

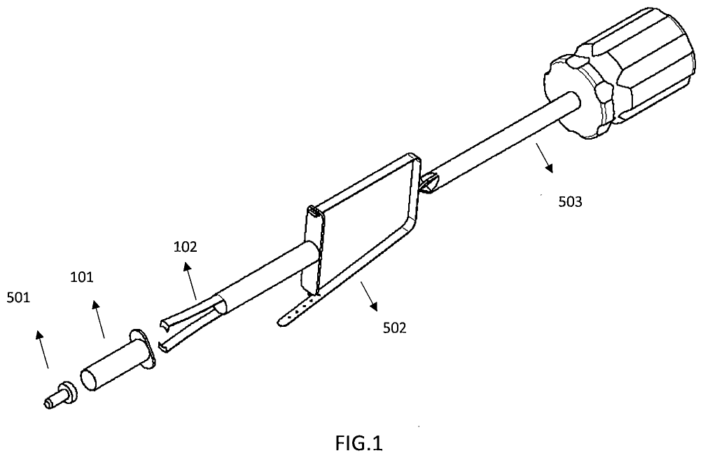

### DETAILED DESCRIPTION OF THE INVENTION

The present invention are the Self expandable screw starters, 100, and the Spring force expand screw starter, 200.

The invention 100 contains three components: Slide locker/un-locker 101, Self-expandable claws 102, and band 502. Claws 102 can be made with two or more claws, for different sizes of screws. Slide 101 can slide along the claws 102 body and make claws 102 contract and extract. There are two ways to hold and positioning the screw 501.

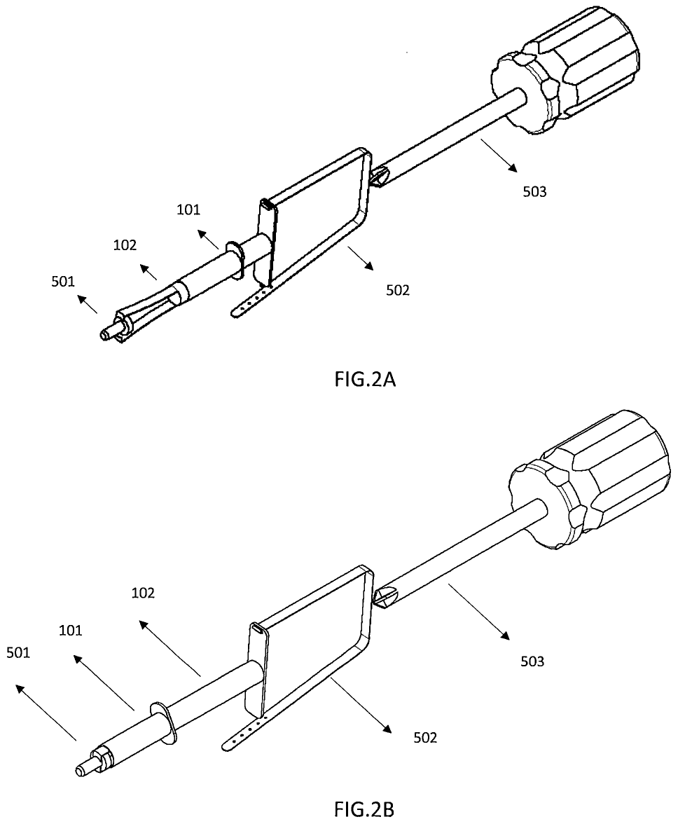

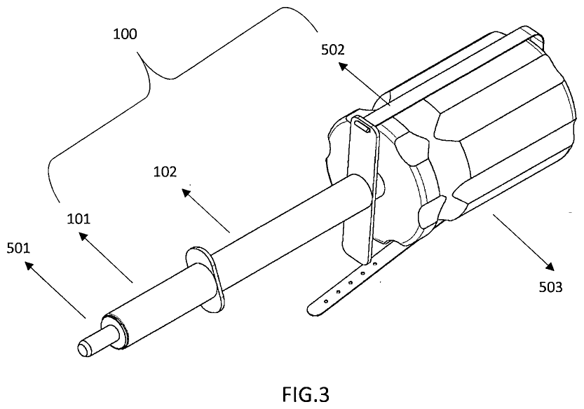

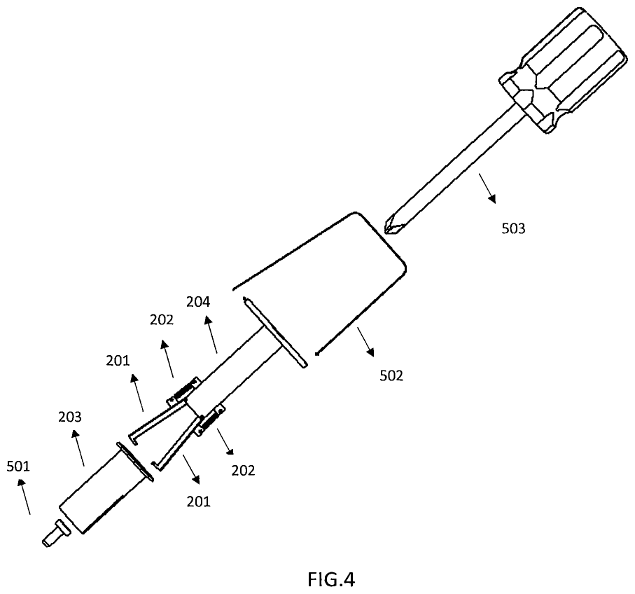

Method 1: Slide 101 stay at the opposite side of the claws, make the claws extract. Insert screw 501. Then move the slide 101 toward to the screw 501. Slide 101 move closer to screw, the claws contract more, until slide 101 reach an end stop on the claws 102, the claws 102 completely contracted. Insert the screwdriver 503 from the flange side of the claws 102, till touch the screw head. The process is shown in FIG. 2A. Finally, use band 502 to tie the screwdriver 503, with the screw starter 100, showing as FIG. 3.

Method 2: Slide 101 stays at the claws side, making the claws 102 contract completely. Then insert screw 501 from the flange side of the claws 102. Hold the claws side down and let the thread part screw 502 come out of the claws. Shows as FIG. 2B. Then insert the screw. driver 503 from the flange side of the claws 102, till touch the screw head Finally, use band 502 to tie the screwdriver 503, with the screw starter 100, showing as FIG. 3.

Then invention 200 contains six components: Claws 201, Spring 202, slide 203, rigid claws base 204, and pivot pin 205. Pivot pin 205 is used to connect claws 201 and claws base 204. Claws 201 can contract and extract along the pivot pin 205 axis. When Slide 203 has no contact with claws 201, the spring 202 will pull up the claws 201, making the claws extract. Moving slide 203 towards the claws side, slide 203 will push the claws 201 to rotate, along the pivot pin 205 axis. Claws 201 will contract. When move the slide 203 up, the claws 201 will extract by the force from spring 202. Slide 203 has an open slot to avoid interference with slide 203. Similar as invention 100, there are two ways to hold and positioning the screw 501.

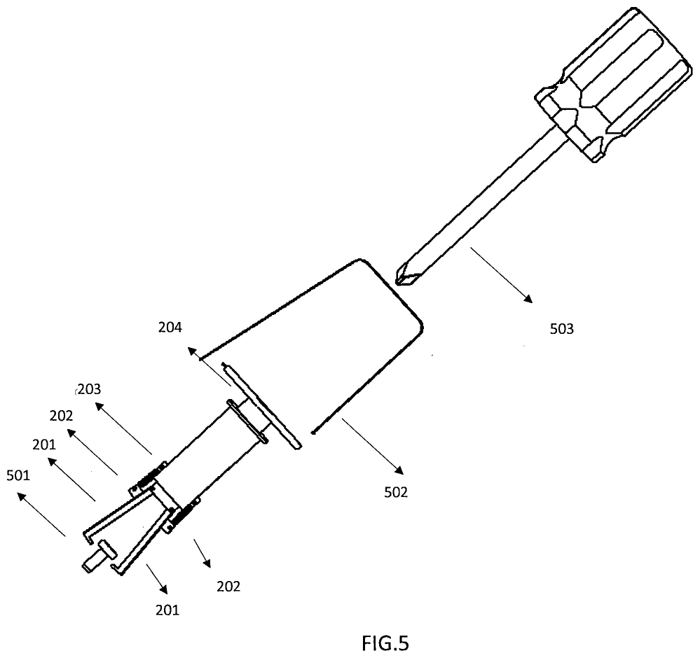

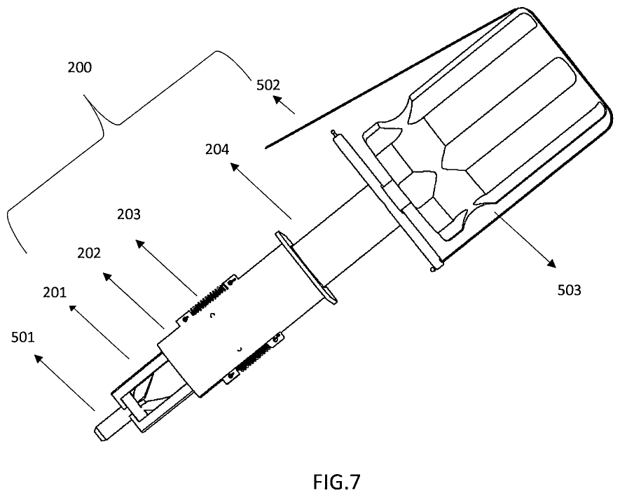

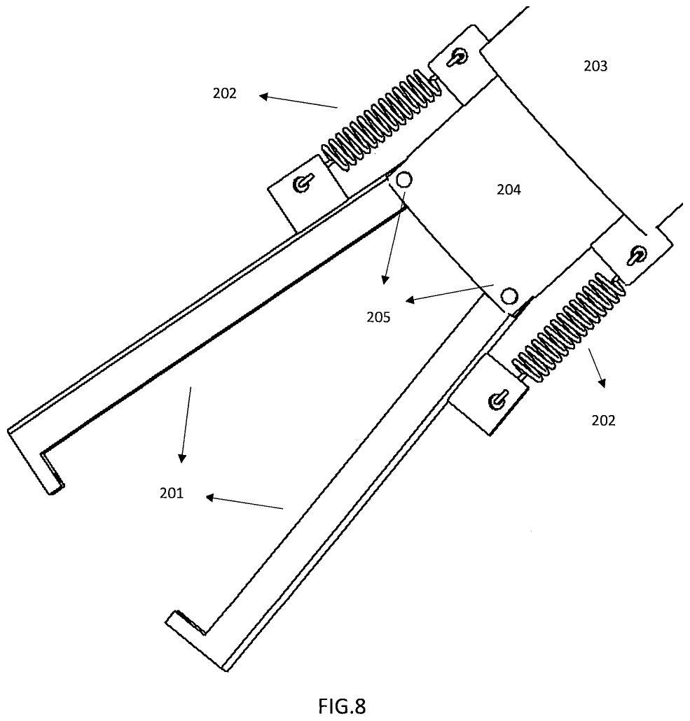

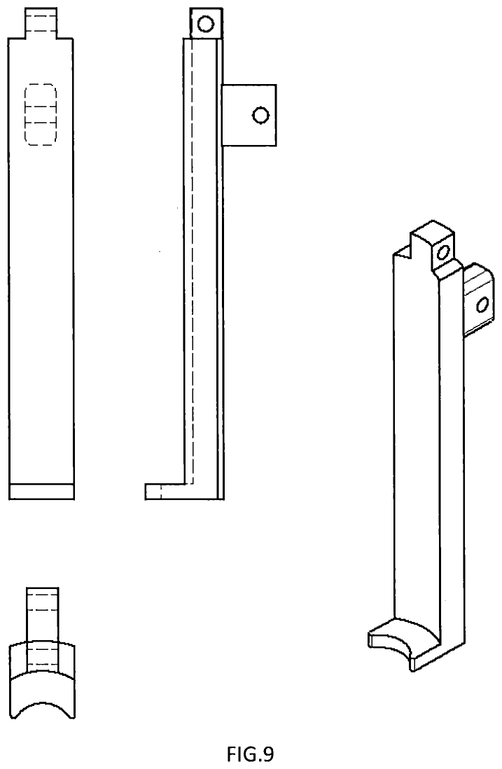

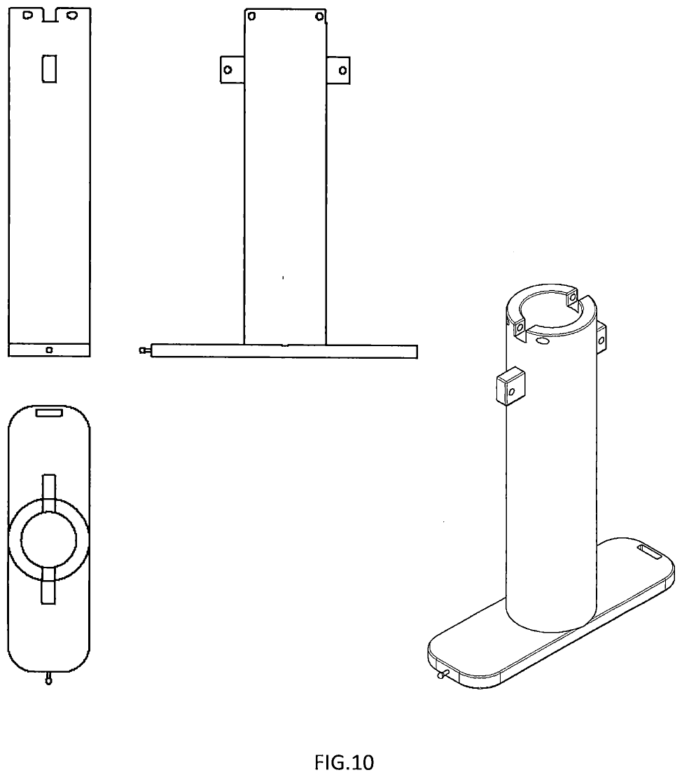

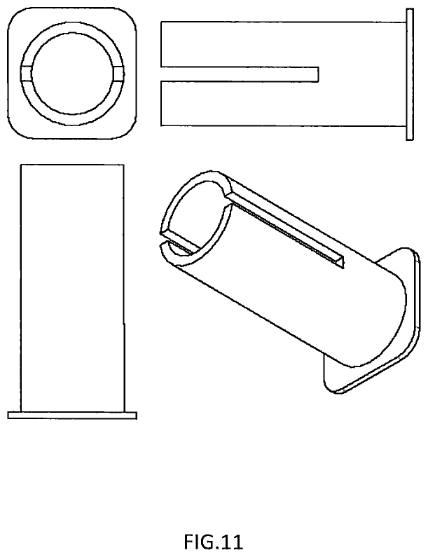

Method 1: Slide 203 stays at the opposite side of the claws, the claw 201 extract by force of spring 202. Insert head of screw 501 from the claw 201 side. Then move the slide 1203 toward to the screw 501. Slide 203 move closer to screw, the claws 201 contract more, until the claws 201 completely contracted. Insert the screwdriver 503 from the flange side of the claws base 204, till touch the screw head. The process is shown as FIG. 5. Finally, use band 502 to tie the screwdriver 503, with the screw starter 200, showing as FIG. 7.

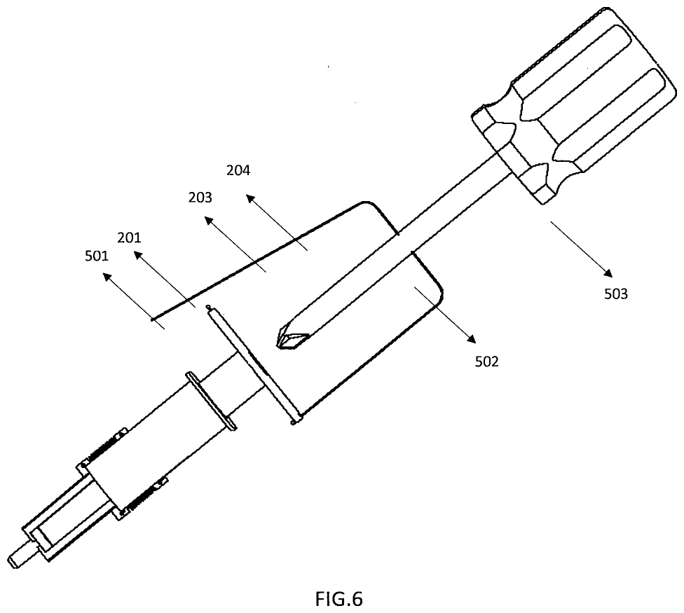

Method 2: Slide 203 stays at the claws side, making the claws 201 contract completely. Then insert screw 501 from the flange side of the claws base 204. Hold the claws side down and let the thread part of screw 502 come out of the claws 201. Shows as FIG. 6. Then insert the screwdriver 503 from the flange side of the claws base 204, till touch the screw head. Finally, use band 502 to tie the screwdriver 503, with the screw starter 100, showing as FIG. 7.

The exact specifications, size of the starter, materials used, and method of use of the invention 100 and 200 may vary upon manufacturing. Slide 101 at invention 100 and slide 203 at invention 200 can be operated manually, also can link to an auto robot, air cylinder for automatic system. The explanation of principles of the invention and particular application will enable others to be able to best utilize and make modifications for specific application.

1. A screw starter, including:
Claws, slide and band; the starter can have two or more claws, used to hold, and positioning a screw; slide is used to lock and unlock the claws with the screw head; A band is used to secure the screwdriver with the starter;
Wherein the claws can extract after the slide locker removed: One type of Claws made by flexible material, which can extract by itself; another type of Claws made with rigid material, and work with a spring, pivot pin to be able to extract by the spring force;
Wherein a slide can move up and down to lock and unlock the starter;
Wherein the claws or the claws base are hollowed so that screw can be feed from both ends, and allow the screwdriver to insert in;
Wherein the band is used to tie the screwdriver with the starter.

2. The claws according to claim 1, wherein the end shape can be circle or polygon and made to different size for different screw.

3. The claws according to claim 1, wherein an end stop mechanism will prevent the slide over traveling.

4. The claws according to claim 1, wherein one type of design is made of elastic material. It can extract by itself.

5. The claws according to claim 1, wherein a slot and a pin, used to work with the band to tie the screwdriver with the starter, are designed at the opposite side of the claws; the pin has a large ball shape end to prevent band come loose.

6. The band according to 1, wherein the material is elastic; one side is bigger than the slot on the claws slot; the other side has multiple holes to match the hook pin at the.

7. The slide according to claim 1, wherein a flange is designed to be able to grab by hand or other automotive devices.
